(19) United States
(12) Patent Application Publication
(10) Pub. No.: US 2004/0196318 A1
(43) Pub. Date: Oct. 7, 2004

(54) Method of depositing phosphor on light emitting diode

(76) Inventors: Massharudin Bin Su, Penang (MY); Yoke Keem Lim, Petaling Jaya (MY); Huch Khim Koay, Penang (MY)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/405,167

(22) Filed: Apr. 1, 2003

(51) Int. Cl. B05D 5/12; B41J 3/00

(52) U.S. Cl. 347/2; 427/66; 118/46

(57) ABSTRACT

A method is directed to coating a light source. The method provides a setup stage, a coating stage and an optional drying stage. The setup stage involves a loading of a luminescent spray solution into a reservoir of an inkjet printer cartridge, a setting of a spraying distance between a platform and the inkjet printer cartridge, and a creation of a spray profile drawing corresponding to the light source. The coating stage involves a secure positioning of the light source on the platform, and a printing of the spray profile drawing where the luminescent material is sprayed upon the diode(s) of the light source. The final drying stage implements a crosslinking technique or curing technique to dry the coated diode(s).

### FIELD OF THE INVENTION

In general, the invention relates to light emitting diodes. More specifically, the invention relates to a method and apparatus for depositing phosphor on a light emitting diode.

### BACKGROUND OF THE INVENTION

Light emitting diodes (LEDs) are increasingly used as a light source for lighting applications. Recently, it has become possible to generate white light from LEDs because of the advent of ultra-violet (UV)/blue LEDs that utilize Gallium Nitride (GaN) based or Indium Gallium Nitride (InGaN) based epitaxial structures.

A type of LED increasingly utilized in lighting applications is a white LED device. The white LED device, as the name implies, emits light that appears white to an observer. In one example, this is achieved by combining an LED, which emits a blue light, and a phosphor such as Cerium-activated Yttrium Aluminum Garnet (Y₃Al₅O₁₂:Ce³⁺). In operation, the LED emits a blue light typically with peak wavelength of 460 to 480 nanometer (nm), referred to as an excitation light wavelength. The phosphor partially absorbs the blue light and re-emits a broadband yellow light with peak wavelength of 560 to 580 nm. The combination, also referred to as a composite light, of the yellow light together with the unabsorbed blue light gives a white color as perceived by the observer of the LED. The quality of white light produced is dependent on the balancing of the blue light with the emission from the phosphor material.

Many approaches have been used to deposit phosphor onto the LED, such as, for example, a time-pressure technique and a roller coating technique. Each of these approaches and many others are designed to fill up a reflector cup of the LED with phosphor. However, the volumetric accuracy is typically unsatisfactory due in part to the settling of the phosphor within the solution.

Another disadvantage is a result of the process of mixing phosphor compounds with an optically-clear substance, such as, for example a clear epoxy resin. It is difficult to achieve and duplicate a uniform mixture of the phosphor compound particles in the optically-clear substance. This difficulty results in a less than desirable uniformity of the light emission from the lighting device.

It would be desirable, therefore, to provide an apparatus and method that would overcome this and other disadvantages.

### SUMMARY OF THE INVENTION

One form of the present invention is a method of operating an inkjet printer to deposit a luminescent spray solution on a light source including at least one diode in accordance with the present invention. First, a luminescent spray solution is loaded into an inkjet printer cartridge of the inkjet printer; and the light source is securely positioned onto a platform of the inkjet printer. A spray profile drawing corresponding to the light source is subsequently printed by the inkjet printer whereby the luminescent spray solution is applied to the at least one diode.

A second form of the present invention provides an inkjet printer constructed in accordance with one embodiment of the invention. The inkjet printer employs a light source assembly, an applicator assembly and a controller for depositing a luminescent material onto at least one diode. The light source assembly includes a platform for securely positioning a light source including the at least one diode. The applicator assembly includes an inkjet printer cartridge for spraying a luminescent spray solution containing the luminescent material onto the at least one diode. The controller controls a spraying of the luminescent spray solution by said inkjet printer cartridge onto the at least one diode in response to a reception of a print command to print a spray profile drawing of the light source.

The foregoing forms and other forms, features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates one embodiment of an inkjet printer constructed in accordance with the present invention;

FIG. 2 illustrates an operational relationship between the inkjet printer illustrated in FIG. 1 and a computer; and

FIG. 3 illustrates a flow chart representative of one embodiment of a luminescent spray method in accordance with the present invention.

### DETAILED DESCRIPTION OF THE PRESENTLY PREFERRED EMBODIMENT

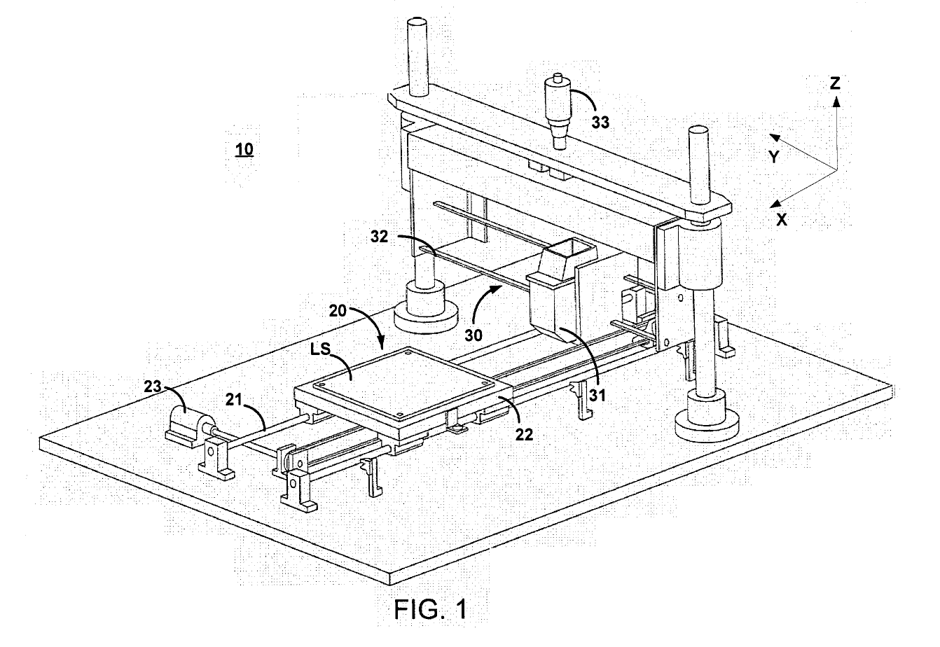

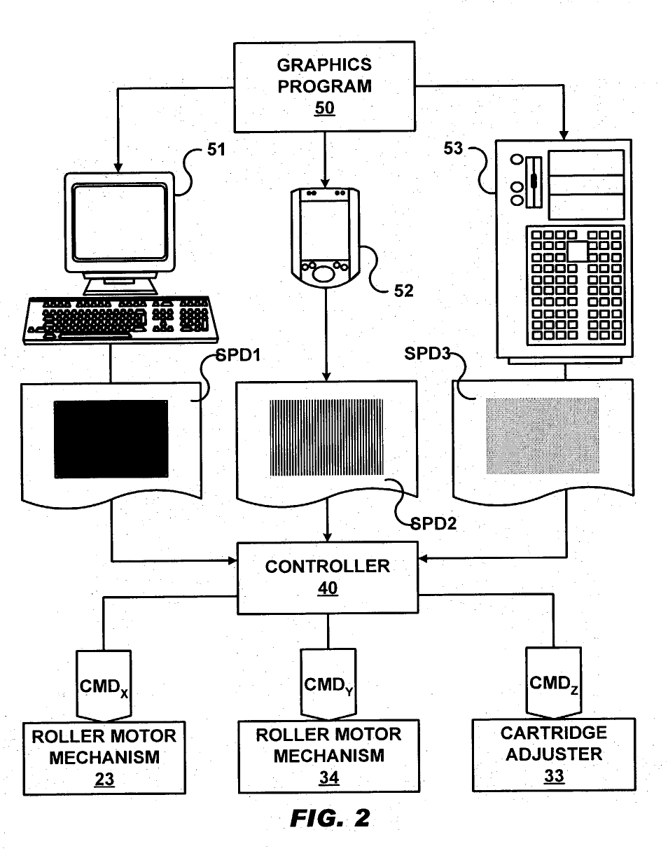

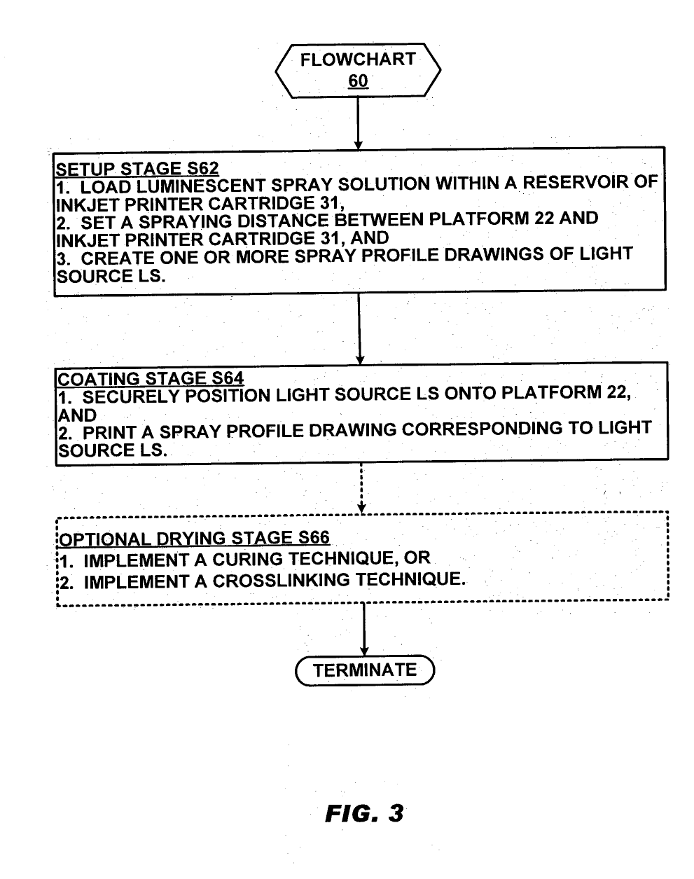

FIG. 1 illustrates an inkjet printer 10 constructed in accordance with the present invention to implement a luminescent spray method of the present invention represented by a flowchart 60 illustrated in FIG. 3. In one embodiment, inkjet printer 10 is implemented as a Hewlett Packard DeskJet 400 inkjet printer (model # dj400) that is adapted to primarily include a feeding mechanism in the form of a light source assembly 20, a spraying mechanism in the form of an applicator assembly 30, and a controller 40 (FIG. 2, not shown in FIG. 1 for clarity purposes). From the following description herein of light source assembly 20, applicator assembly 30, and controller 40, those having ordinary skill in the art will appreciate secondary components of inkjet printer 10 that are needed to support an operation of light source assembly 20, applicator assembly 30, and controller 40.

Light source assembly 20 includes a platform 22 that is movable along a set of rails 21 in an X-direction via a roller motor mechanism 23 as commanded by controller 40 via a command CMD_{X} (FIG. 2). Roller motor mechanism 23 may be the paper roller motor from inkjet printer 10 and mounted to the base platform 22. Platform 22 is operable to securely support a light source LS including one or more light emitting diodes, laser diodes or any other type of diode suitable for the luminescent spray method of the present invention. Light source LS is implemented in any number of packages, such as, for example, a surface-mount package, a reflector cup mounting package, or a through-hole package. In one embodiment, light source LS is implemented as a wafer after light emitting diodes or laser diodes are fabricated, but prior to separation of the wafer into individual light emitting diodes or laser diodes. In a second embodiment, light source LS is implemented as light emitting diodes or laser diodes post fabrication. In a third embodiment, light source LS is implemented as an individual light emitting diode or an individual laser diode.

Applicator assembly 30 includes an inkjet printer cartridge 31 that is movable along a set of belts or rails 32 in a Y-direction via a roller motor mechanism 34 (FIG. 2, not shown in FIG. 1 for clarity purposes) as commanded by controller 40 via a command CMD_{Y} (FIG. 2). Inkjet printer cartridge 31 is preferably implemented as an inkjet printer cartridge (e.g., a Hewlett Packard inkjet printer cartridge model #HP 51625A) having a luminescent spray solution contained within a reservoir of inkjet printer cartridge 31.

In one embodiment, the luminescent spray solution is implemented as U-Lite Phosphor Suspension 2.0 and 3.0 available from Winchem of Prai,Penang.

In a second embodiment, the luminescent spray solution additionally includes a surfactant that assists in suspending the luminescent material within the spray solution. The type of surfactant used is dependent, in part, on the substrate material utilized. For example, when glass or silicon is implemented as a substrate material, silanated compound is preferably utilized as a surfactant. In another example, when fillers and fibers are implemented as substrate materials, titanates are preferably utilized as a surfactant or coupling agent.

In a third embodiment, the reservoir of inkjet printer cartridge 31 includes a partial obstruction that additionally mixes the luminescent spray solution to further suspend the luminescent material within the spray solution. In an example, the partial obstruction is implemented as a mill ball.

Applicator assembly 30 further includes a cartridge adjustor 33 implemented as a precision measuring device to adjust inkjet printer cartridge 31 in a Z-direction at a predetermined distance from rails 21. In an example, cartridge adjustor 33 is implemented as a micro-meter. In a first embodiment, cartridge adjustor 33 is manually adjusted to position inkjet printer cartridge 31 in the Z-direction. In a second embodiment, cartridge adjustor 33 positions inkjet printer cartridge 31 in the Z-direction as commanded by controller 40 via a command CMD_{Z} (FIG. 2). Those having ordinary skill in the art will appreciate the required programming of controller 40 in controlling cartridge adjuster 33.

FIG. 2 illustrates an operational relationship between inkjet printer 10 and a computer such as, for example, a desktop personal computer 51, a hand held personal computer 52 and a server 53 as illustrated in FIG. 2. Each computer stores a graphics program (e.g., Microsoft® PowerPoint® or Microsoft® Visio®) within a storage device (e.g., a hard drive, a compact disc drive, etc.). The computers and controller 40 further include hardware and software interfaces required to print a document on inkjet printer 10. Those having ordinary skill in the art will appreciate other types of computers that can be employed with inkjet printer 10.

Referring to FIGS. 1-3, three (3) acts occur during a setup stage S62 of flowchart 60. One act is a loading of the luminescent spray solution within the reservoir of inkjet printer cartridge 31. The second act is a selective manual or automated adjustment of cartridge adjuster 31 to set a spraying distance between an applicator of inkjet printer cartridge 31 and platform 22. The third act is to use the graphics program 50 to create a spray profile drawing for the light source LS, such as, for example, the spray profile drawings SPD1-SPD3 illustrated in FIG. 2. Spray profile drawing SPD1 has a print area for spraying the luminescent spray solution on an entire area of the light source LS irrespective of the diode arrangement on the light source LS. Spray profile drawing SPD2 has a print area for spraying the luminescent spray solution in a row format when the light source LS has a row arrangement of diodes. Spray profile drawing SPD3 has a print area for spraying individual diodes of light source LS.

In practice, those having ordinary skill in the art will appreciate that the spray distance set between inkjet printer cartridge 31 and platform 22, and the spray profile drawing(s) are co-dependent upon a desired amount of coating as well as the arrangement of diodes on light source LS.

Two (2) acts occur during a coating stage S64 of flowchart 60. A first act is a secure positioning of light source LS onto platform 22. This act can further include covering the light source LS with a spray profile drawing where the diode(s) are exposed through a cutout of the print area of the spray profile drawing. The second act is a use of the computer to provide a print command to controller 40 to print the spray profile drawing corresponding to the light source whereby the luminescent spray solution is applied to the light source LS in accordance with the spray profile drawing. One or more of the aforementioned acts of coating stage S64 can be repeated as many times as necessary to achieve a desired degree of coating of the luminescent spray solution on light source LS.

One of two (2) acts occurs during an optional drying stage S66 of flowchart 60. One act is an implementation of a crosslinking technique, which is a manufacturing process term referring to a chemical reaction resulting in the bonding of the molecules together to form a macromolecule. The other act is an implementation of a curing technique, which is a manufacturing process term referring to the process whereby a material transforms from a liquid or partially crosslinked material to a fully crosslinked material. In an example, the curing process is implemented with a heat cure system, an ultra violet (UV) curing system, or a microwave curing system. In this example, the UV curing system speeds the curing process with respect to the heat cure system.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of operating an inkjet printer to deposit a luminescent spray solution on a light source including at least one diode, said method comprising:
loading a luminescent spray solution into an inkjet printer cartridge of the inkjet printer;
securely positioning the light source onto a platform of the inkjet printer; and
printing a spray profile drawing corresponding to the light source whereby the luminescent spray solution is applied to the at least one diode.

2. The method of claim 1, further comprising:
setting spraying distance between the platform and the inkjet printer cartridge.

3. The method of claim 1, further comprising:
drying the luminescent spray solution applied to the at least one diode.

4. The method of claim 3, wherein the drying of the luminescent spray solution applied to the at least one diode includes implementing a curing technique.

5. The method of claim 3, wherein the drying of the luminescent spray solution applied to the at least one diode includes implementing a crosslinking technique.

6. An inkjet printer for depositing a luminescent material onto at least one diode, said inkjet printer comprising:
a light source assembly including a platform for securely positioning a light source including the at least one diode;
an applicator assembly including an inkjet printer cartridge for spraying a luminescent spray solution containing the luminescent material onto the at least one diode; and
a controller for controlling a spraying of the luminescent spray solution by said inkjet printer cartridge onto the at least one diode in response to a reception of a print command to print a spray profile drawing corresponding to the light source.

7. The inkjet printer of claim 8, wherein said applicator assembly further includes a cartridge adjuster for setting a spray distance between said platform and said inkjet printer cartridge.

8. An inkjet printer for depositing a luminescent material onto at least one diode, said inkjet printer comprising:
a light source assembly including means for securely positioning a light source including the at least one diode;
an applicator assembly including means for spraying a luminescent spray solution containing the luminescent material onto the at least one diode; and
a controller for controlling a spraying of the luminescent spray solution by said inkjet printer cartridge onto the at least one diode in response to a reception of a print command to print a spray profile drawing corresponding to the light source.

9. The inkjet printer of claim 10, wherein said applicator assembly further includes means for setting a spray distance between said platform and said inkjet printer cartridge.
